(19) United States
(12) Patent Application Publication
(10) Pub. No.: US 2017/0037647 A1
(43) Pub. Date: Feb. 9, 2017

(54) POOL LADDER SYSTEM

(71) Applicant: Northern Stainless & Rail Products (1995) Inc, Pickering (CA)

(72) Inventor: David Edward Gartner, Pickering (CA)

(21) Appl. No.: 14/819,047

(22) Filed: Aug. 5, 2015

(51) Int. Cl. E04H 4/14; E06C 7/42; E06C 1/06; E06C 7/18

(52) U.S. Cl. CPC E04H 4/144; E06C 7/182; E06C 7/42; E06C 1/06

(57) ABSTRACT

A pool assembly including a swimming pool with a deck surrounding the same. A ladder is provided to get into and out of the pool. The ladder includes a handrail assembly secured to the deck and a separate stair assembly secured to the pool's sidewall. The handrail assembly and stair assembly are vertically aligned with each other but are spaced a distance apart. A pool cover is movable between a first position where the cover extends over the pool, and a second position where the cover is retracted to one end of the pool. Neither the handrail assembly nor the stair assembly is removed from their engagement with the deck or sidewall, respectively, when the cover is moved between the first and second positions. The cover may be engaged with tracks, one of which is positioned between the handrail and stair assemblies.

### BACKGROUND OF THE INVENTION

Technical Field

This application relates generally to swimming pools. More particularly, this application relates to pool ladders. Specifically, this application is directed to a pool ladder comprising separate handrail assembly and stair assemblies, where the handrail assembly is engaged in receiving tubes in the pool deck above the top level of a quantity of water held in the pool and the stair assembly is engaged in waterproof sockets in the pool's sidewall and therefore below the top level of the water.

Background Information

Swimming pools may have automatic or manual safety covers that are rolled up and stored on a spool assembly on the pool deck at one end of the pool. The covers are often engaged with and slide along tracks on either side of the pool so that they are firmly attached at each end and are more easily deployed and retracted. Because of the engagement of the cover with the tracks and because the covers are typically made from a sturdy material such as nylon, if a person or animal walks or falls on the cover, the cover will prevent them from falling into the pool. The cover will tend not to become detached from these tracks during such incidents.

In addition to safety covers, many pool owners utilize pool blankets to help increase and/or maintain the water temperature. The blankets are rolled over the pool at night or on cold days and are rolled up and stored on the deck in a similar manner to pool covers when it is desired to use the pool. These blankets may be manually or automatically deployed and float on the surface of the pool and may be manually or automatically withdrawn therefrom.

At the same time, many pools are equipped with some type of ladder that extends into the water and aids swimmers in getting into and out of the pool. Typically these ladders are single unitary component comprised of two spaced apart tubular rails that are connected together by a number of steps proximate one end of the ladder. The section of the ladder that is designed to be above the water includes two curved bars that are able to be raised up to approximately 18-24 inches in order to provide hand holds for entry into the pool and exit therefrom. The ends of these two bars are each inserted into a receiving pipe provided in the pool deck. The rest of the ladder drops down into the pool and under the water. This underwater section of the ladder includes the plurality of steps. The lower end of the ladder that is underwater rests against the sidewall of the pool and is not secured thereto in any way. To remove the ladder, the user will simply pull upwardly on the handrail assembly section of the bars so that the ends of the ladder will slide out of the two receiving pipes in the deck. One of the issues that these pool ladders present is that they need to be removed from the receiving pipes in order to deploy a pool cover or pool blanket.

### SUMMARY

There is therefore a need in the art for a type of pool ladder that does not need to be disengaged from the pool deck in order to deploy a pool cover or pool blanket. Such an improved pool ladder is disclosed in this document.

A pool assembly includes a swimming pool with a deck surrounding the same. A ladder is provided to get into and out of the pool. The ladder includes a handrail assembly secured to the deck and a separate stair assembly secured to the pool's sidewall. The handrail assembly and stair assembly are vertically aligned with each other but are spaced a distance apart. A pool cover is movable between a first position, where the cover extends over the pool, and a second position where the cover is retracted to one end of the pool. Neither the handrail assembly nor the stair assembly is removed from their engagement with the deck or sidewall, respectively, when the cover is moved between the first and second positions. The cover may be engaged with tracks, one of which is positioned between the handrail and stair assemblies.

In one aspect, the invention may provide a ladder for a pool comprising a handrail assembly adapted to be secured to a deck surrounding the pool; and a separate stair assembly adapted to be secured to a sidewall of the pool.

In another aspect, the invention may provide a method of mounting a pool ladder adjacent a pool, said method comprising providing a ladder comprising a handrail assembly and a separate stair assembly; engaging the handrail assembly to a deck of the pool; and engaging the stair assembly to a sidewall of the pool a distance vertically below the handrail assembly.

In another aspect, the invention may provide a pool assembly comprising a swimming pool including a bottom wall, a sidewall extending upwardly from the bottom wall; said bottom wall and sidewall defining a cavity adapted to receive a quantity of water therein; a deck extending laterally outwardly from a top end of the sidewall, said deck extending along each side of the pool and along one end of the pool; a pool ladder assembly comprising a handrail assembly secured to the deck adjacent one side of the pool and a separate stair assembly secured to the sidewall of the pool, where the handrail assembly and stair assembly are vertically aligned with each other; and a cover movable between a first position where the cover extends over the pool and a second position where the cover is retracted to a location at one end of the pool; and wherein neither the handrail assembly nor the stair assembly is removed from their engagement with the deck or sidewall, respectively, when the cover is moved between the first and second positions.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is a perspective view of a swimming pool with a ladder in accordance with an aspect of the present invention provided adjacent thereto; and with the pool cover or blanket in a retracted position;

FIG. 2 is a perspective view of the swimming pool and ladder with the pool blanket or cover partially deployed;

FIG. 3 is a perspective view of the swimming pool and ladder with the pool blanket or cover fully deployed;

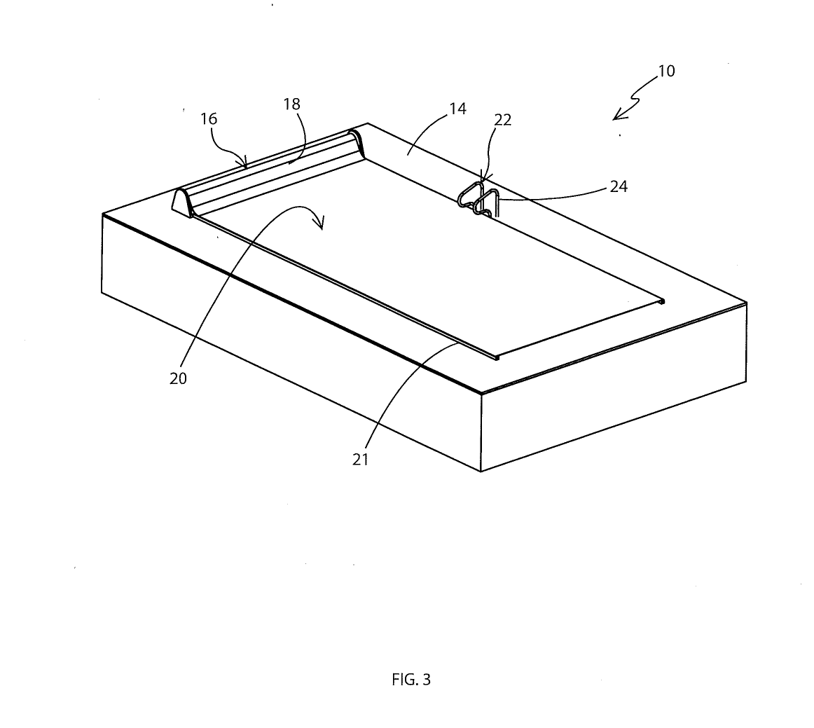

FIG. 4 is a perspective view of the pool ladder in accordance with the present invention shown installed partially on the pool deck and partially in the pool wall;

FIG. 5 is a front view of the pool ladder of FIG. 4;

FIG. 6 is a top view thereof;

FIG. 7 is a side view of the pool ladder shown mounted on a steel section of a pool typical of vinyl pool construction;

FIG. 8 is an exploded perspective view of the pool ladder and pool sidewall and deck illustrated in FIG. 7, where the arrangement of the various components of the ladder is useful for a pre-existing pool;

FIG. 9 is an exploded side view of the pool ladder, pool sidewall and deck shown in FIG. 8;

FIG. 10 is an enlarged first cross-sectional view of the highlighted region of FIG. 7;

FIG. 11 is a front view of the socket shown in FIG. 10; cross-sectional side view of one socket with the ladder tube installed;

FIG. 12 is an enlarged second cross-sectional view of the highlighted region of FIG. 7 showing the cross-section taken through a different set of fasteners from that illustrated in FIG. 10;

FIG. 13 is an exploded side view of the pool ladder, pool sidewall and deck for a new construction pool; and

FIG. 14 is an enlarged cross-sectional view of one socket of the pool ladder useful for the new construction pool shown in FIG. 13.

Similar numbers refer to similar parts throughout the drawings.

### DETAILED DESCRIPTION

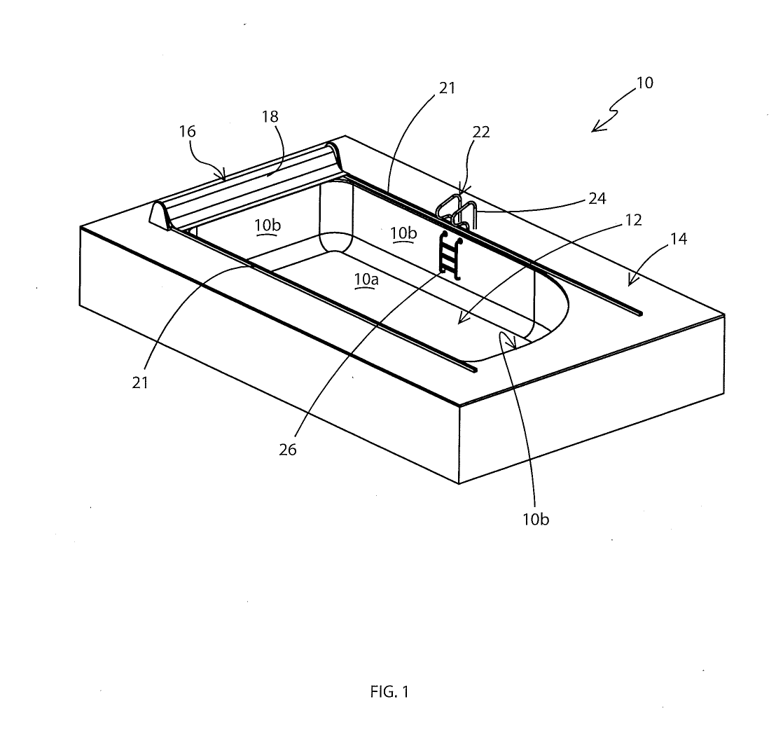

Referring to FIG. 1, there is shown a swimming pool 10. Pool 10 has a bottom wall 10a with a sidewall 10b extending upwardly and outwardly therefrom. Bottom wall 10a and sidewall 10b bound and define a cavity 12 that retains a quantity of water therein. A deck 14 circumscribes an opening to the cavity 12 of pool 10. Deck 14 originates at a top end of sidewall 10b and extends laterally outwardly therefrom, terminating a distance away from sidewall 10b.

Pool 10 may be of any style of construction including but not limited to vinyl construction, fiberglass construction or concrete construction. For convenience, the pool 10 illustrated and described herein is of vinyl construction meaning that the pool sidewall 10b is formed from steel plate and is then covered with a vinyl liner. Deck 14 comprises a concrete apron that circumscribes the opening to cavity 12. The ladder to be described herein can, however, be used with any type of pool construction.

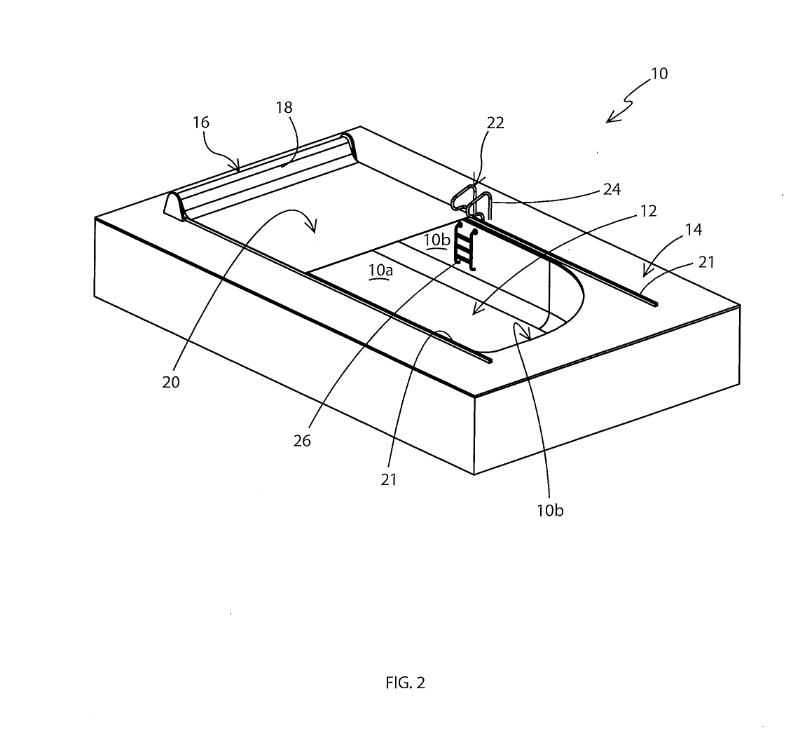

A cover assembly 16 may be provided adjacent one end of pool 10. Cover assembly 16 includes a housing 18 and a cover 20 (FIG. 2) that is selectively extendable out of housing 18 and over cavity 12 and any water received therein; and is retractable back into housing 18. Cover 20 may be a safety cover, a thermal blanket, a net or any other type of structure that may be moved in a first direction to extend over the opening to cavity 12 of pool 10 and thereby block access to the water or to the cavity 12. Cover 20 may also be moved in a second direction where the cover 20 is withdrawn from across the opening to cavity 12 and may further be retracted into housing 18. When cover 20 is withdrawn in this manner access to the water or to cavity 12 is once again possible.

A pool ladder in accordance with an aspect of the present invention is provided for climbing into and out of pool 10 and is indicated herein by reference number 22. Ladder 22 comprises a handrail assembly 24 and a stair assembly 26. Handrail assembly 24 and stair assemblies are completely separate components that are used together. Handrail assembly 24 is an upper part of ladder 22 that is engaged on deck 14 and is entirely out of the water in pool 10. Stair assembly 26 is a lower part of ladder 22 that is engaged with sidewall 10b. Stair assembly 26 is therefore entirely under the water or is almost entirely under of the water. Stair assembly 26 will be almost entirely under the water if, for some reason, the water level in the pool is set low enough for part of the uppermost end of stair assembly 26 to project out of the water. None of the stair assembly 26, however, passes above the region where the upper end of sidewall 10b joins deck 14.

It will be understood that handrail assembly 24 and stair assembly 26 are each detachably engaged with the associated deck 14 or sidewall 10b, respectively, and may be removed therefrom if and when desired. However, the configuration of ladder 22 makes it possible to keep handrail assembly 24 and stair assembly 26 engaged in the associated deck 14 or sidewall 10b during the deployment (manual or automatic) of cover 20 over the opening to pool and the withdrawal of the same.

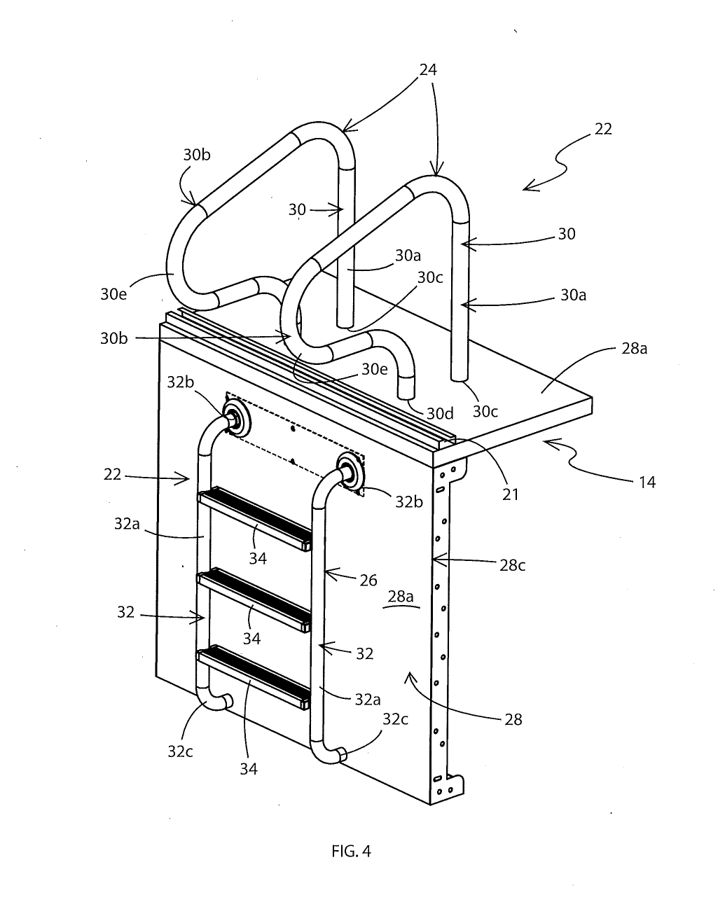

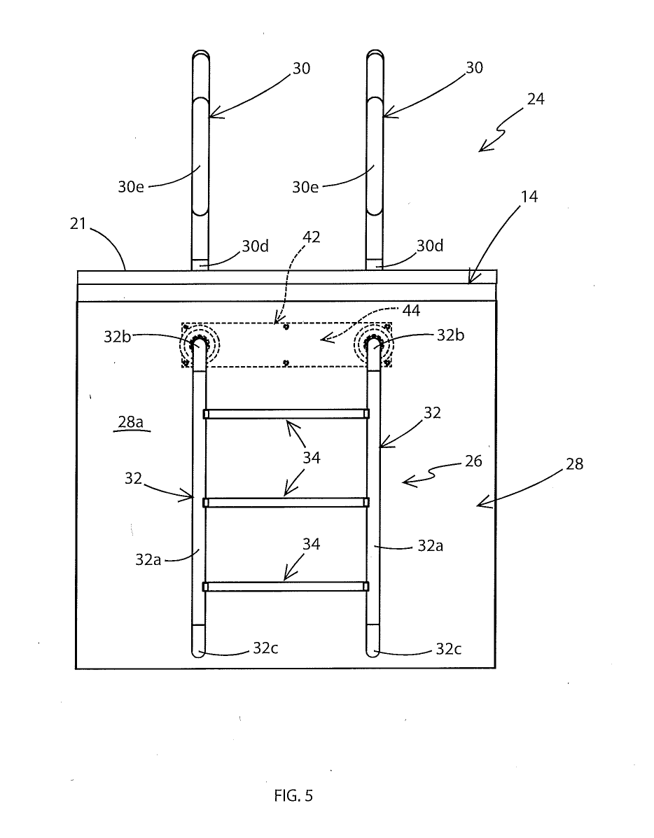

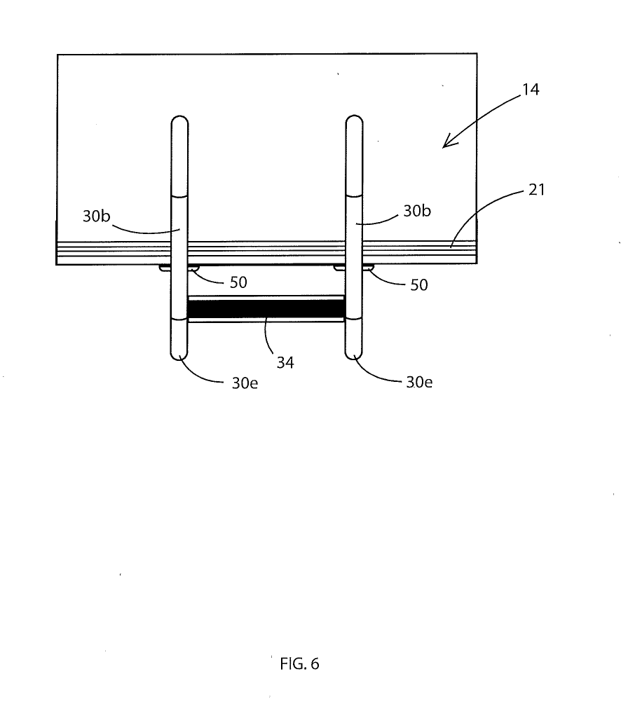

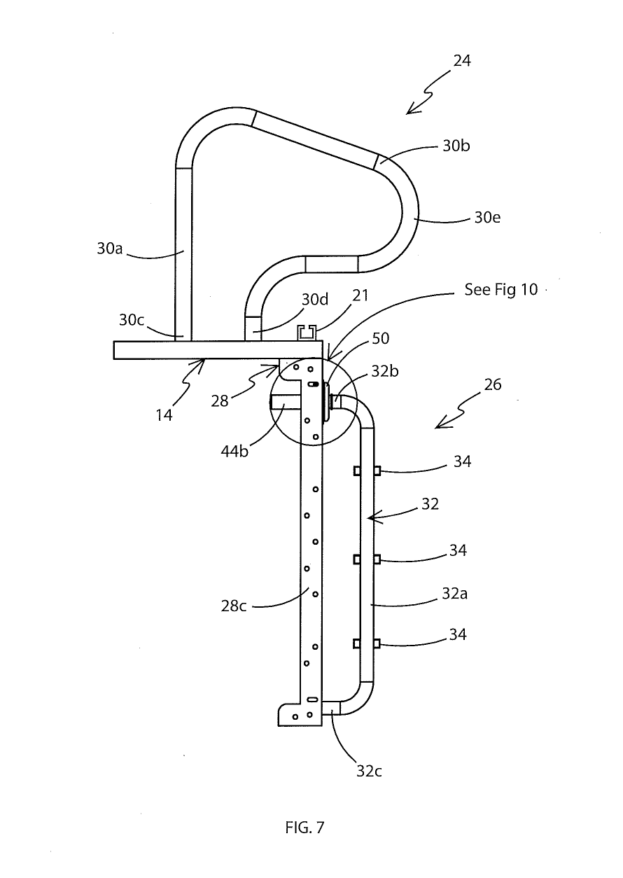

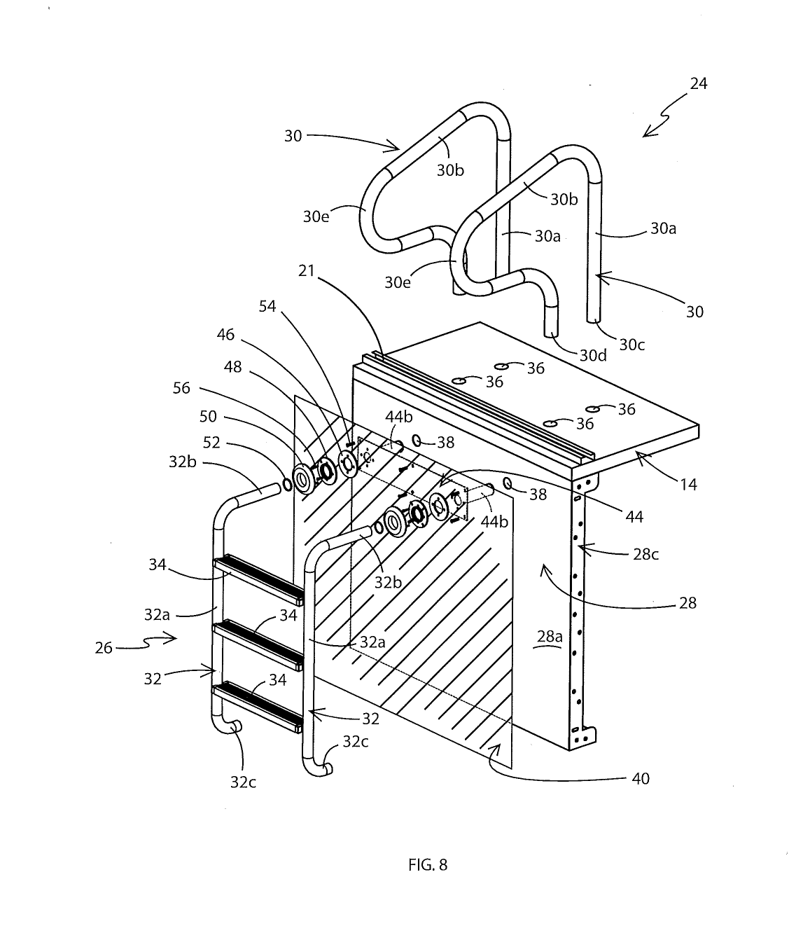

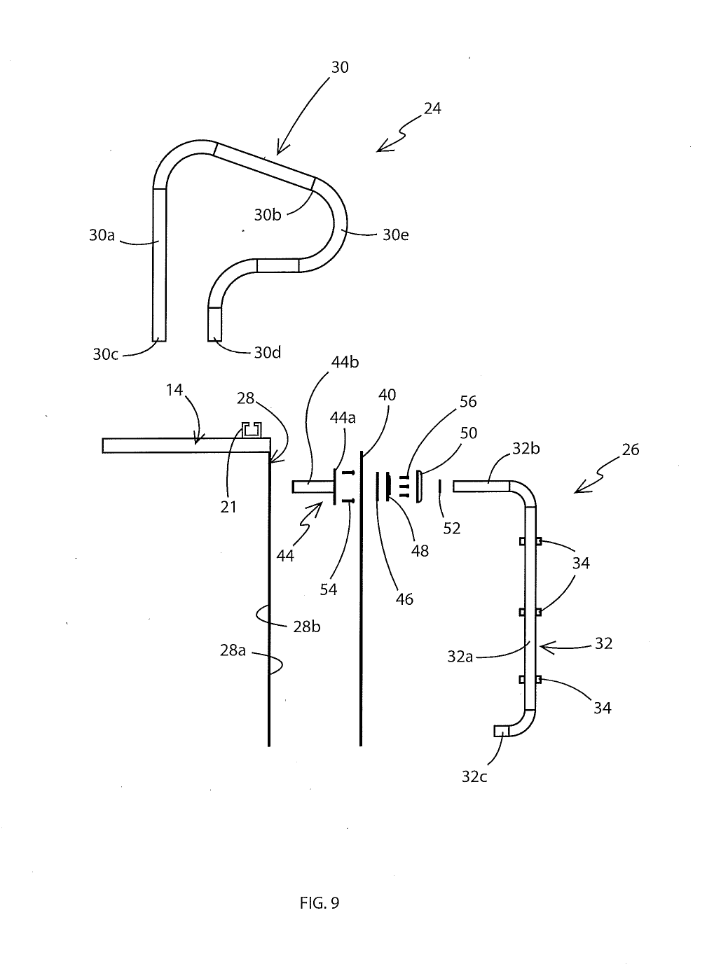

FIGS. 4-9 show ladder 22 in greater detail. Because pool 10 is of a vinyl construction, sidewall 10b is illustrated as comprising a section of a steel wall 28. Steel wall 28 has an exterior surface 28a, an interior surface 28b (FIG. 9) and is secured between supports 28c, one of which is shown in FIG. 8. A section of a concrete deck 14 is illustrated as being oriented generally at right angles to steel wall 28.

Handrail assembly 24 comprises two separate handles 30 that are substantially identical in shape. Each handle 30 is tubular and is shaped to include a generally vertical section 30a and a curved section 30b that extends outwardly from one end of vertical section 30a. Vertical section 30a includes a first end 30c and curved section 30b includes a second end 30d. First and second ends 30c, 30d of handle 30 are shaped and sized to be inserted into receiving tubes 36 provided in deck 14. Thus, each handle 30 is secured in two locations to deck 14. Curved section 30b of each handle 30 is generally S-shaped and includes a U-shaped bend 30e which will project for a distance inwardly beyond sidewall 10b and over cavity 12. It is these projecting bends 30e that will be grasped by a swimmer when climbing out of the water.

It will be understood that the two handles 30 of handrail assembly 24 may be fabricated as a single unit. This may be accomplished by connecting one or more cross-braces between handles 30. The cross-brace may be located proximate first ends 30c or second ends 30d or both. The cross-brace would need to located so that it will rest on deck 14 when first and second ends 30c, 30d are inserted into receiving tubes 36 so that the cross-brace will not interfere with a swimmer climbing into or out of pool 10 using ladder 22

Stair assembly 26 of ladder 22 comprises two bars 32 that are substantially parallel and spaced apart from each other. Each bar 32 is generally U-shaped and includes a generally straight central section 32a, a first end 32b, and a second end 32c. First and second ends 32c, 32c curve away from opposite ends of central section 32a in generally the same direction. First and second ends 32c, 32c are oriented generally at right angles relative to central section 32a. Bars 32 are spaced a distance laterally apart from each other and one or more steps 34 extend between central sections 32a of bars 32 and are secured thereto. Steps 34 are spaced a distance longitudinally from each other along central sections 32a.

Handrail assembly 24 and stair assembly 26 are completely separate components that are mounted to different parts of the pool and surrounding structure. As discussed earlier herein, in previously known pool systems and ladders, a single ladder component would be engaged with the pool deck by engaging one end thereof in receiving tubes in the deck. Consequently, in previously known systems, the pool ladder would only have two connection points to the pool deck, namely the two ends of the upper part of the ladder inserted into the two receiving tubes. The other end of the ladder would simply touch the sidewall of the pool but would not be secured in any way to the sidewall of the pool. The section between these ladder ends would interfere with any movement of a track-engaged cover across the opening to the pool.

In ladder 22 by comparison, both handrail assembly 24 and stair assembly 26 are secured in place. Handrail assembly 24 is secured in four places to deck 14 in that each of the first and second ends 30c, 30d of both handles 30 is inserted into a receiving tube 36 (FIG. 8) defined in the concrete pad which forms deck 14.

Stair assembly 26 has an upper end and a lower end. First ends 32b comprise the upper end of stair assembly 26 and second ends 32c comprise the second end of stair assembly 26. The upper end of stair assembly is detachably secured to sidewall 10b while lower end of stair assembly 26 rests against sidewall 10b. Upper end is secured in two places to pool sidewall 10b in that first end 32b of each bar 32 of stair assembly 26 is engaged in one of the sockets provided in a socket assembly 42. The socket assembly 42 is secured to the sidewall 10b in such a way that portions thereof are inserted into apertures 38 in sidewall 10b or are aligned with apertures 38. When first ends 32b are engaged with socket assembly 42, first ends 32b are oriented generally at right angles to sidewall 10b. Second ends 32c of bars 32 simply rest against sidewall 10b. Second ends 32c may be oriented generally at right angles relative to sidewall 10b so that steps 34 are positioned generally horizontally.

So, unlike previously known systems where the pool ladders were only secured to the deck of the pool in two locations, ladder 22 is secured in six locations. In some instances it may even be desirable to secure second ends 32c of bars 32 to pool sidewall 10b in a similar fashion to the way in which first ends 32b are secured thereto. The securement of first ends 32b will be discussed below.

In previously known systems the vinyl liner which overlayed the steel wall had to be free of any tears, apertures or slits. If any of these breaks existed in the vinyl liner then some of the water tended to drain out of the pool. In the current system, apertures are purposefully cut in the vinyl liner 40 in order to install stair assembly 26. However, these apertures in vinyl liner 40 then have to be sealed in some fashion so that water will not tend to drain from pool 10. As illustrated in the attached figures, the socket assembly 42 is configured to connect stair assembly 26 to steel wall 28 in such a manner that the connection is substantially sealed and waterproof and thereby substantially prevents water from draining out of pool 10 therethrough.

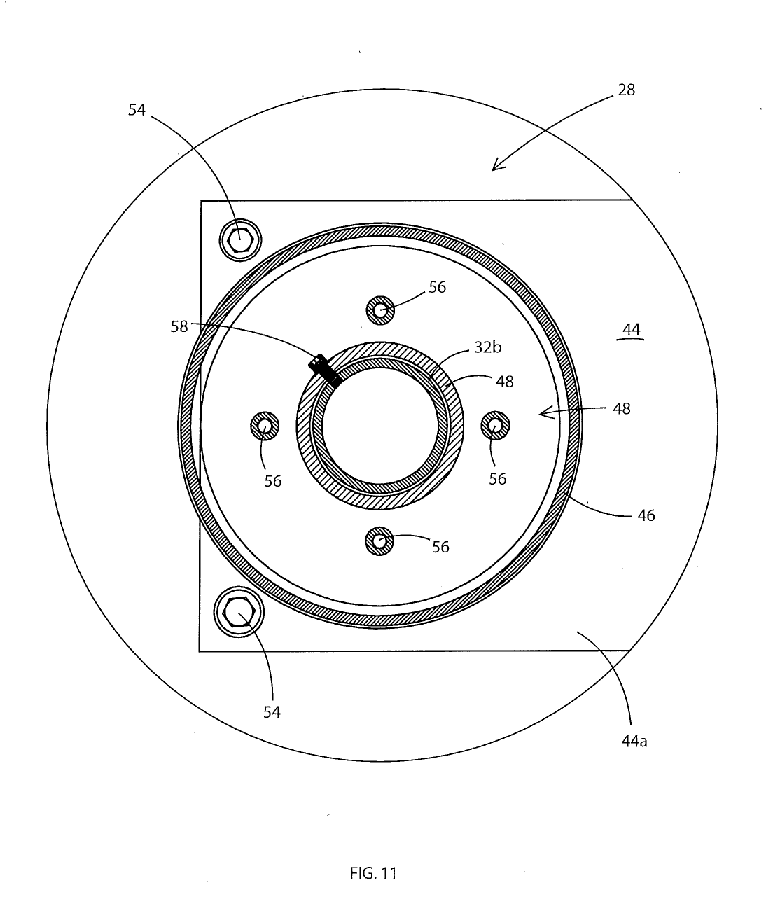

Socket assembly 42 includes a mounting plate 44, a pair of flexible rubber gaskets 46, a pair of flanges 48, a pair of collars 50 and a pair of O-rings 52. Assembly 42 also includes a plurality of fasteners 54, 56, 58. Mounting plate 44a includes a planar member 44a and two spaced apart tubular members 44b that extend outwardly from an inner surface of planar member 44a in generally the same direction and are oriented generally parallel to each other. Tubular members 44b are welded to the inner surface of planar member 44a. Tubular members 44b are designed to be inserted through apertures 38 in steel wall 28 (or through similar apertures in a fiberglass wall or concrete wall, depending on the pool's construction). Each tubular member 44b has a peripheral wall that defines a bore 44c (FIG. 11) therein which is sized and shaped to be complementary to first ends 32b of bars 32. The bore 44c is open at one end and the end of tubular member 44b opposite that opening is closed off so that if water does manage to enter tubular member 44b, that water will not be able to exit the tubular member 44b other than through the opening at the one end.

One of the gaskets 46 is placed adjacent the exterior surface of planar member 44a such that a central aperture (shown in FIG. 8 but not numbered) in gasket 46 will be aligned with the opening to bore 44c. Flange 48 is placed adjacent gasket 46 and so that the central aperture (shown in FIG. 8 but not numbered) therein is aligned with the aperture in gasket 46. Collar 50 and O-ring 52 are positioned adjacent flange 48 and so that central apertures (shown in FIG. 8 but not numbered) defined in collar 50 and O-ring 52 will align with the apertures in flange 48, gasket 46 and with bore 44c of tubular member 44b. Gaskets 46 are used to seal flanges 46 to vinyl liner 40. Collar 50 is a plastic or metal component that is attached to flange 48 to provide a watertight seal. Appropriate fasteners 54, 56 are used to secure the various components to each other and to planar member 44a.

This combination of planar member 44a, tubular member 44b, gasket 46, flange 48, collar 50 and O-ring 52 forms a waterproof socket into which one of first ends 32b of stair assembly 26 may be inserted. Socket assembly 42 therefore provides two spaced apart sockets that are able to receive the first ends 32b of stair assembly 26 therein and secure the same to sidewall 10b of pool 10. Planar member 44a is provided to ensure that the two sockets are spaced the correct distance apart from each other to accurately and adequately engage the uppermost end of stair assembly 26.

Each fastener 58 acts as a locking member that secures the upper end of ladder 22 to socket assembly 42. Each fastener 58 is inserted through one of a plurality of radial holes (shown in FIG. 8 but not numbered) in flange 48 and through an aligned radial hole (shown in FIG. 8 but not numbered) in first end 32b to lock first end 32b of stair assembly 26 to socket assembly 42. This locking engagement of fastener 58, flange 48 and first end 32b helps to ensure that stair assembly 26 will not be able to be pulled out of the sockets in socket assembly 42 during normal use of stair assembly 26 by a swimmer in climbing into or out of pool 10.

It will be understood that if the pool in question is a fiberglass pool or a concrete pool and not a structure made with steel wall 28 covered with vinyl liner 40, then socket assembly 42 will be used to secure stair assembly 26 to the fiberglass sidewall or concrete sidewall and vinyl liner 40 will be omitted from the system.

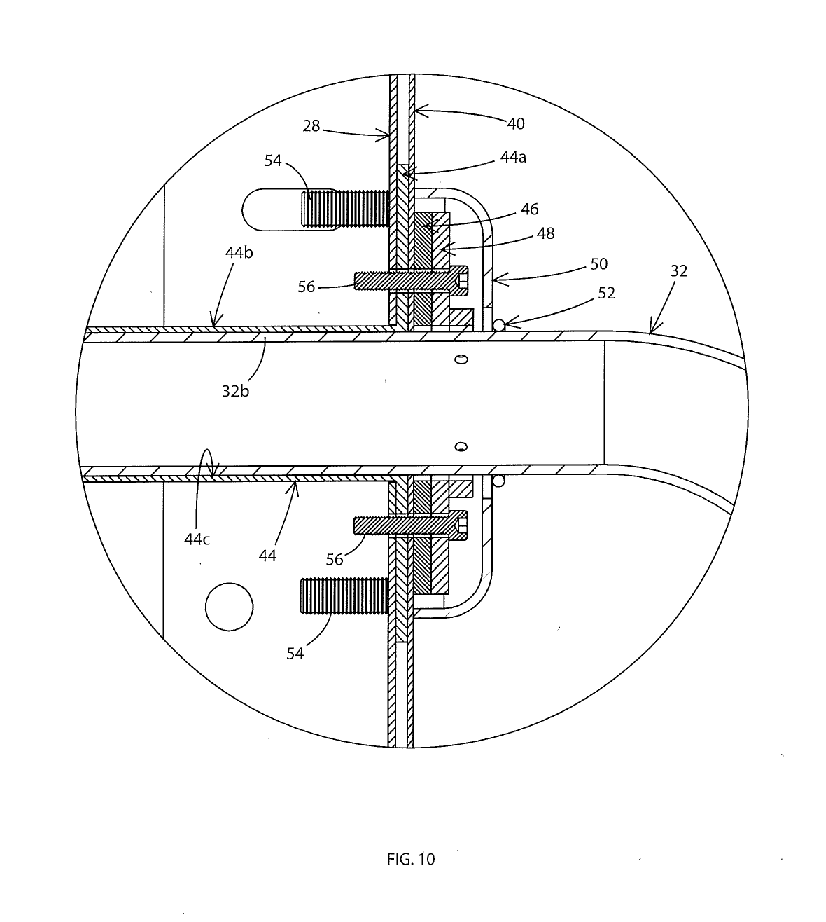

FIGS. 8-12 show a first example of an installation of ladder 22. This installation is directed to an instance where ladder 22 is installed in an existing pool that has a concrete deck 14 already in place. Initially, vinyl liner 40 is detached from the top end of sidewall 10b as is pulled back for a distance to expose that portion of the steel wall 28 to which socket assembly 42 is to be engaged. Once steel wall 28 is exposed, two apertures 38 are drilled into the same. Apertures 38 are spaced from each other and are horizontally aligned. Socket assembly 42 is then engaged with steel wall 28. This is accomplished by inserting each tubular member 44b of socket assembly 42 into one of the apertures 38. Planar member 44a is then pushed toward steel wall 28 until the inner surface of mounting plate 44 is in abutting contact with exterior surface 28a (FIG. 9) of steel wall 28. Fasteners 54 are used to secure planar member of mounting plate 44a to steel wall 28. Vinyl liner 40 is then pulled back into position and re-attached, thus covering mounting plate 44 and the previously exposed section of steel wall 28. Apertures are cut in vinyl liner 40 so that each aperture aligns with one of the openings to bore 44c of the tubular member 44b.

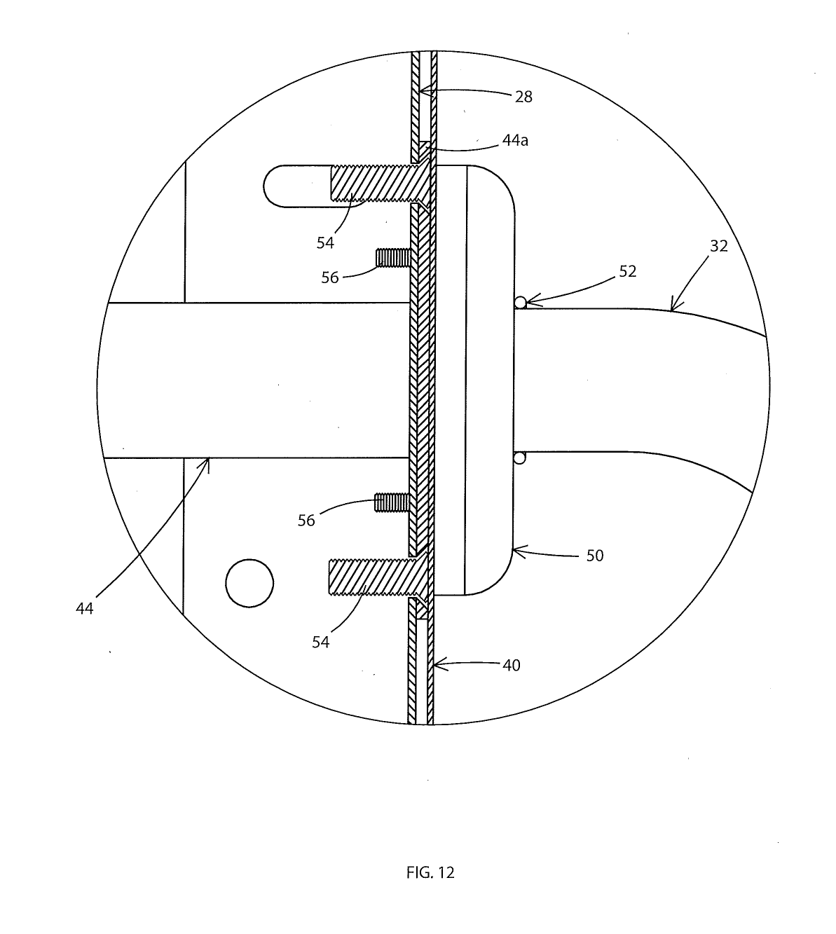

Rubber gaskets 46 are positioned adjacent vinyl liner 40 and flanges 46 are positioned adjacent gaskets 46 in such a way that a through-passage is created by all of the various apertures therein. Flanges 46 are secured to planar member 44a of mounting plate 44a utilizing fasteners 56. A collar 50 and 0-ring 52 are positioned on each first end 32b of bar 32 and the first end 32b is then inserted through the aligned apertures defined by flange 48 and gasket 46 and into the bore 44c of the associated tubular members 44b. Once first end 32b has been pushed inwardly into bore 44c to a sufficient degree, a fastener 58 (FIG. 12) is inserted through one of a plurality of radial holes in flange 48 and into an aligned radial hole in first end 32b. Fasteners 58 are located on the water side of the socket and are used to bias the inserted first ends 32b into engagement with the other components of the socket assembly 42. Collar 50 and O-ring 52 are slid along the exterior wall of the first ends 32b and are snapped into engagement with collar 50. Once the first ends 32b of bars 32 are engaged with socket assembly 42 in this manner, the second ends 32c of each bar 32 are positioned to rest against the vinyl liner 40 and thereby against steel wall 28. Ladder 22 may then be used to climb into and out of pool.

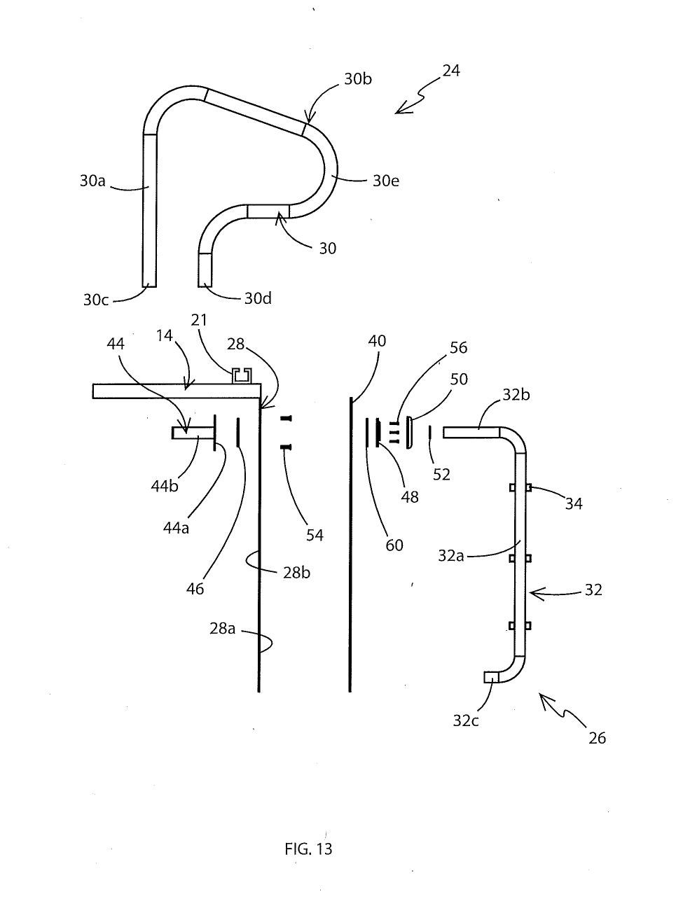

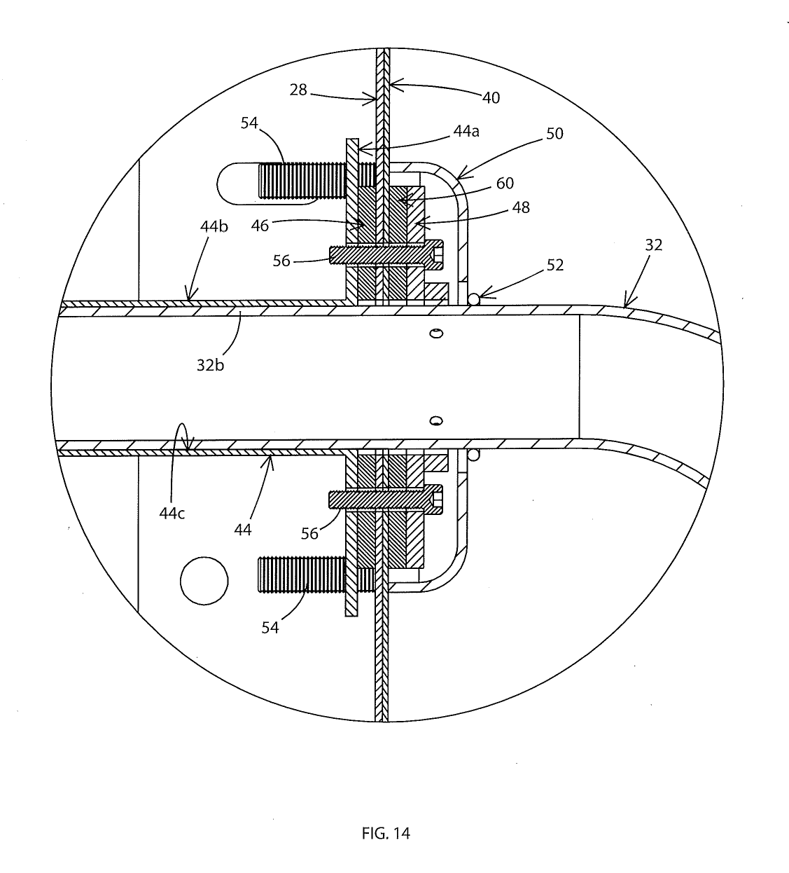

FIGS. 13 and 14 illustrates a slightly different manner of installing the two-component ladder 22 to deck 14 and sidewall 10b. In this particular instance the installation relates to new construction where the concrete apron that will form deck 14 is not yet installed. Consequently, there is access to the rear surface of steel wall 28. Handrail assembly 24 is installed in deck 14 in the same manner as described above with reference to the system illustrated in FIGS. 8-12. The installation of the underwater stair portion 26 is, however, different from what is illustrated in FIGS. 8-12. In this second installation example the mounting plate 44a and a pair of gaskets 46 are positioned adjacent to the interior surface 28b of steel wall 28 so that bores 44c of the two tubular members 44b align with apertures 38 in steel wall 28. Fasteners 54 are utilized to secure mounting plate 44a and gaskets 46 in place. Vinyl liner 40 is positioned adjacent to the exterior surface 28a of steel wall 28, flexible second rubber gaskets 60 are positioned adjacent vinyl liner 40 and flanges 46 are positioned adjacent second gaskets 60 such that the apertures of these various components are aligned with bores 44c of tubular members 44. Fasteners 56 secure flanges 46 to mounting plate 44. Collars 50 and O-rings 52 are positioned around first ends 32b of bars 32 and the first ends 32b are inserted through the various aligned apertures and into the bores 44c of the two tubular members 44b. A fastener 58 is again utilized to lock each first end 32b to one of the flanges 46, Collar 50 is engaged with the associated flange 48 by snap-fitting the two components together. O-ring 52 which is engaged with collar 50 ensures that the socket is sealed. While first ends 32b are engaged and secured in place by socket assembly 42, second ends 32c of bars 32 are positioned to rest against vinyl liner 40 and thereby against steel wall 28.

Because handrail assembly 24 and stair assembly 26 are separated from each other there are no components that cross the divide between the deck 14 and sidewall 10b. Consequently, when it is desired to move pool cover 20 in a first direction to cover the opening to cavity 12 and cut off access to the water, there are not obstacles presented by ladder 22 to the movement of cover 20. There is similarly no obstacle to the movement of the cover in a second direction as cover 20 is withdrawn from across the opening to cavity 12. Ladder 22 is therefore able to remain engaged with deck 14 and with sidewall 10b during the deployment and retraction of cover 20.

A method of mounting pool ladder 22 adjacent pool 10 comprises providing a ladder 22 comprising a handrail assembly 24 and a separate stair assembly 26; engaging handrail assembly 24 to deck 14 of pool 10; and engaging stair assembly 26 to sidewall 10b of pool 10 a distance vertically below handrail assembly 24.

The step of engaging handrail assembly 24 comprises inserting first end 30c and second end 30d of handrail assembly 24 into a pair of receiving tubes 36 provided in deck 14.

The step of engaging stair assembly 26 comprises inserting an upper end (i.e., first ends 32b) of stair assembly 26 into one or more receiving tubes 38 in sidewall 10b and resting the lower end (i.e., second ends 32c) of stair assembly 26 against sidewall 10b.

The method further includes positioning handrail assembly 24 above the water retained in cavity 12 and positioning stair assembly 26 below the water and sealing the upper end of stair assembly 26 to sidewall 10b. The step of sealing comprises providing socket assembly 42 including mounting plate 44 with a pair of tubular members 44b extending outwardly therefrom; securing mounting plate 44 to sidewall 10b; inserting first ends 32b of a pair of bars 32 at the upper end of stair assembly 26 into the pair of tubular members 44b; and sealing the first ends 32b of the pair of bars 32 into the tubular members 44b.

The inserted first ends 32b are then locked into socket assembly 42.

The step of securing mounting plate 44 further comprises aligning the pair of tubular members 44b on mounting plate 44 with a pair of apertures 38 defined in sidewall 10b; installing fasteners 54 to secure mounting plate 44 to sidewall 10b; positioning vinyl liner 40 over sidewall 10b1 and covering mounting plate 44a; cutting a pair of apertures in the vinyl liner 40 so that these apertures align with bores 44c defined by tubular members 44b; positioning a pair of gaskets 46 adjacent vinyl liner 40 such that apertures defined by gaskets 46 aligns with the bores 44c of the pair of tubular members 44b; and securing a pair of flanges 46 to the mounting plate 44 where each of the flanges 46 is positioned adjacent one of gaskets 46 such that apertures in flanges 46 align with bores 44c of tubular members 44b.

The method further includes inserting each of first ends 32b of stair assembly 26 through the aperture of the associated flange 48, through the aperture of the associated gasket 46, through the associated aperture in the vinyl liner 40; and into bore 44c defined by the associated one of the pair of tubular members 44b. Fastener 58 is inserted through a radial hole defined in each flange 48 and into an aligned radial hole in the associated first end 32b of stair assembly 26.

The method may include inserting each tubular member 44b through an aperture 38 in sidewall 10b and positioning an interior surface of mounting plate 44 adjacent an exterior surface of the sidewall 10b.

The method may further include positioning a second gasket 60 adjacent an interior surface of sidewall 10b; aligning an aperture in second gasket 60 with an aperture 38 defined in sidewall 10b; positioning an exterior surface of mounting plate 44 adjacent second gasket 60; and aligning bore 44c of each tubular member 44b with one of the aligned apertures in second gasket 60 and aperture 38 in sidewall 10b.

There is thus disclosed herein a pool assembly comprising a swimming pool 10 including a bottom wall 10a, a sidewall 10b extending upwardly from bottom wall 10a said bottom wall 10a and sidewall 10b defining a cavity 12 adapted to receive a quantity of water therein; a deck 14 extending laterally outwardly from a top end of sidewall 10b (i.e., remote from bottom wall 10a), said deck 14 extending along each side of pool 10 and along one end of pool 10; a pool ladder 22 comprising a handrail assembly 24 secured to deck 14 adjacent one side of pool 10 and a separate stair assembly 26 secured to sidewall 10b of pool 10, where handrail assembly 24 and stair assembly 26 are vertically aligned with each other; a cover 20 movable between a first position where cover 20 extends over pool 10 to a second position where cover 20 is retracted to a location at one end of pool 10 (such as in cover assembly 16); and wherein neither handrail assembly 24 nor stair assembly 26 is removed from their engagement with deck 14 or sidewall 10b, respectively, when the cover 20 is moved between the first and second positions.

The pool assembly further comprises a pair of tracks 21, where tracks 21 are positioned on deck 14 on opposite sides of pool 10, wherein one of the pair of tracks 21 may be located between handrail assembly 24 and a top end of sidewall 10b; and wherein cover 20 is engaged with tracks 21 and is movable therealong between the first and second positions.

It will be understood that instead of ladder 22 having two first ends 32b that are engaged in socket assembly 42 and thereby secured to sidewall 10b, ladder 22 may be configured so that the two bars 32 merge toward the upper end thereof and provide only a single first end for engagement with a socket assembly. In this instance, the socket assembly will be constructed to have only one socket for securement of this single first end. Alternatively, the two bars 32 may present more than two first ends 32b for engagement with a socket assembly. For example, the two bars 32 may merge and present three first ends for engagement with a socket assembly; in which case that socket assembly will present three sockets for securement of the upper end of the ladder thereto. Still further, each bar 32 may be separated from each other but split near the upper end and present two first ends each for engagement with a socket assembly; in which instance four first ends will be presented by the ladder and the socket assembly will accordingly provide four sockets for engagement therewith.

Similarly, while handrail assembly 24 is disclosed herein as having both a first end 30c and a second end 30d that are received in receiving tubes in deck 14, each rail 30 may only be secured at one or the other of the first and second ends 30c or 30d. Alternatively, an additional leg may be provided on handrail assembly 24 and provide a third end that is engaged in a receiving tube in deck 14.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

1. A ladder for a pool comprising:
a handrail assembly adapted to be secured to a deck surrounding the pool; and
a separate stair assembly adapted to be secured to a sidewall of the pool.

2. The pool ladder as defined in claim 1, wherein the handrail assembly and the stair assembly are vertically aligned with each other and are spaced a distance apart.

3. The pool ladder as defined in claim 1, wherein the stair assembly has an upper end and a lower end; wherein the upper end is adapted to be secured to the sidewall of the pool.

4. The pool ladder assembly as defined in claim 3, further comprising a socket assembly that engages the upper end of the stair assembly and is adapted to secure the upper end of the stair assembly to the sidewall of the pool.

5. The pool ladder assembly as defined in claim 4, further comprising a locking member; where the locking member secures the upper end of the stair assembly to the socket assembly.

6. The pool ladder assembly as defined in claim 4, wherein the socket assembly includes:
a mounting plate comprising:
a planar member defining one or more apertures therein; and
one or more tubular members extending outwardly from the planar member; wherein each of the one or more tubular members defines a bore therein; and wherein each of the one or more apertures comprises an opening to one of the one or more bores; and wherein the upper end of the stair assembly is received in the one or more tubular members.

7. The pool ladder as defined in claim 6, wherein the stair assembly comprises:
a first bar and a second bars that are substantially parallel and spaced apart, each of the first and second bars having a central section, a first end and a second end; wherein the first ends of the first and second bars comprise the upper end of the stair assembly and the second ends of the first and second bars comprise the lower end thereof; and
one or more steps extend between the central sections of the first and second bars.

8. The pool ladder as defined in claim 7, wherein the mounting plate includes two apertures and two tubular members; and the first ends of the first and second bars are received in the bores of the two tubular members.

9. The pool ladder as defined in claim 7, wherein the second end of each of the first and second bars is oriented generally at right angles to the central section thereof; and when the first ends are engaged with the socket assembly, the second ends are adapted to rest against the sidewall of the pool.

10. The pool ladder as defined in claim 6, wherein the socket assembly further comprises:
one or more flanges positioned adjacent the planar member, each of the one or more flanges defining an aperture therein that is aligned with the bore of one of the one or more tubular members.

11. The pool ladder as defined in claim 10, further comprising:
one or more gaskets positioned between the planar member and the one or more flanges, the one or more gaskets defining an aperture therein that is alignable with the bore of the one or more tubular members.

12. The pool ladder assembly as defined in claim 11, further comprising one or more collars engageable around each of the one or more flanges.

13. A method of mounting a pool ladder adjacent a pool, said method comprising:
providing a ladder comprising a handrail assembly and a separate stair assembly;
engaging the handrail assembly to a deck of the pool; and
engaging the stair assembly to a sidewall of the pool a distance vertically below the handrail assembly.

14. The method as defined in claim 13, wherein the step of engaging the handrail assembly comprises inserting a first end and a second end of the handrail assembly into a pair of receiving tubes provided in the deck of the pool.

15. The method as defined in claim 13, wherein the step of engaging the stair assembly comprises inserting an upper end of the stair assembly into one or more receiving tubes in a sidewall of the pool.

16. The method as defined in claim 15, further comprising resting a lower end of the stair assembly against the sidewall of the pool.

17. The method as defined in claim 13, further including positioning the handrail assembly above a top level of a quantity of water held by the pool and positioning the stair assembly below the top level of the water.

18. The method as defined in claim 17, further comprising:
sealing an upper end of the stair assembly to the sidewall of the pool.

19. The method as defined in claim 18, wherein the step of sealing further comprises:
providing a socket assembly including a mounting plate with a pair of tubular members extending outwardly therefrom;
securing the mounting plate to the sidewall of the pool;
inserting first ends of a pair of bars at the upper end of the stair assembly into the pair of tubular members; and
sealing the first ends of the pair of bars into the tubular members.

20. The method as defined in claim 19, further comprising locking the inserted first ends of the pair of bars to the socket assembly.

21. A pool assembly comprising:
a swimming pool including a bottom wall, a sidewall extending upwardly from the bottom wall; said bottom wall and sidewall defining a cavity adapted to receive a quantity of water therein;
a deck extending laterally outwardly from a top end of the sidewall, said deck extending along each side of the pool and along an end of the pool;
a pool ladder assembly comprising a handrail assembly secured to the deck adjacent one side of the pool and a separate stair assembly secured to the sidewall of the pool, where the handrail assembly and stair assembly are vertically aligned with each other; and
a cover movable between a first position where the cover extends over the pool and a second position where the cover is retracted to a location at one end of the pool; and wherein neither the handrail assembly nor the stair assembly is removed from their engagement with the deck or sidewall, respectively, when the cover is moved between the first and second positions.

22. The pool assembly as defined in claim 21, further comprising a pair of tracks, where the tracks are positioned on the deck on opposite sides of the pool, wherein one of the pair of tracks is located between the handrail assembly and a top end of the sidewall of the pool; and wherein the cover is engaged with the tracks and is movable therealong between the first and second positions.
